(19) United States
(12) Patent Application Publication
(10) Pub. No.: US 2012/0073675 A1
(43) Pub. Date: Mar. 29, 2012

(54) STORAGE TANK SYSTEM HAVING EASE OF PLACEMENT AND INTERCONNECTIVITY

(75) Inventors: Darcy DUPUIS, Devon (CA); Philip David STASIEWICH, Edmonton (CA); James STASIEWICH, Edmonton (CA); Kenneth GRAD, Edmonton (CA)

(73) Assignee: STRAD ENERGY SERVICES LTD., Calgary (CA)

(21) Appl. No.: 13/245,798

(22) Filed: Sep. 26, 2011

Related U.S. Application Data
(60) Provisional application No. 61/386,457, filed on Sep. 24, 2010.

(51) Int. Cl. B08B 9/00

(52) U.S. Cl. 137/238

(57) ABSTRACT

A storage tank system stores liquid containing debris. The sidewalls of the tank have a curved lower portion for receiving debris settling out of the liquid and for directing at least some of the debris to a base of the tank. The tank is also provided with a plurality of nozzles spaced longitudinally along the curved lower portion the sidewalls for directing flush liquid downwardly against the curved lower portion for flushing any residual debris remaining thereon towards the bottom of the tank. The tank has a skid equipped with rollers for improved manoeuvrability in a berm environment and manifolds for improved interconnectability with other tanks.

### CROSS REFERENCE TO RELATED APPLICATIONS

This application claims the benefits under 35 U.S.C 119(e) of U.S. Provisional Application Ser. No. 61/386,457, filed Sep. 24, 2010, which are incorporated fully herein by reference.

### FIELD OF THE INVENTION

Embodiments described herein relate generally to one or more storage tanks for liquids carrying debris, systems for fluid interconnection of multiple tanks and particular tank design enabling safe manoeuvring in containment areas such as bermed areas.

### BACKGROUND OF THE INVENTION

Typically, conventional storage tanks for drilling fluids or muds, used in the oil and gas industry, have a rectangular planar geometry inside the tank including horizontal surfaces upon which debris carried in the mud can settle and accumulate. Often agitators are used during working of the tank or in periodic maintenance including the use of pressured liquid or steam to dislodge debris. Such maintenance is time consuming and expensive.

Typical mud tanks weigh around 500,000 pounds and are normally located in a spill containment area or berm. Berms are intended to capture accidental loss of liquids from such tanks and integrity of the berm's liquid-containing layer is critical. When placing such tanks, it is a known challenge to manoeuvre these tanks into place in the containment area without disturbing or damaging the integrity of the floor of the berm. To date, Applicant is not aware of an effective and safe way to place tanks off of transport vehicles. Conventional cranes, pickers and swampers, not otherwise required on site, are very expensive to being in temporarily. There is a need to be able to use onsite equipment to safely manoeuvre tanks with minimal risk to the berm integrity, with an objective to provide a time, safety and cost advantage.

### SUMMARY OF THE INVENTION

Embodiments described herein are directed to a storage tank comprising a bottom having a lower curved portion which is curved for urging the debris contained in the liquid stored in the tank to a base of the tank.

Embodiments described herein are also directed to various systems associated with the tank such as debris-flush system, a manoeuvring roller system and fluid connections between multiple tanks in a tank farm.

Accordingly in one broad aspect a storage tank system for the storage of liquid, containing debris, is provided. The tank system comprises a tank having a front wall and a back wall spaced longitudinally apart by two sidewalls for defining an enclosed area for storing the liquid. Each sidewall has an upper portion and a curved lower portion forming a bottom. The curved lower portion receives debris settling out of the liquid and directs at least some of the debris to a base of the bottom the tank. The system further comprises a plurality of nozzles spaced longitudinally along the curved lower portion of at least one of two sidewalls for directing flush liquid downwardly against the curved lower portion for flushing any residual debris remaining thereon towards the base of the tank.

Accordingly in another broad aspect a storage tank system having manoeuvrable tanks in a containment area is provided. The tank system comprises a tank having a bottom, a front wall and a back wall spaced longitudinally apart by two sidewalls for defining an enclosed area for storing the liquid. The system also comprises a skid extending along the tank for supporting the bottom of the tank and engaging a floor of the containment area. The system further comprises rollers located along a bottom edge of the skid adjacent a first end of the tank. The first end can be either the front wall or the back wall. The rollers engage the floor and support the weight of the first end of the tank in a manoeuvring position for manoeuvring within the containment area when a second end of the tank is lifted off the floor. The second end can be either the front wall or the back wall respectively.

Accordingly in another broad aspect a storage tank farm is provided. The tank farm comprises a plurality of the tanks. Each tank has at least one interconnection means. Each tank is fluidly connected in parallel by at least an outlet to an adjacent tank using fluid conduits connected between the at least one interconnection means of each tank. In one embodiment, the interconnection means is housed in a heated cabinet.

### BRIEF DESCRIPTION OF THE DRAWINGS

FIG. 1 is a side view of a storage tank according to one embodiment;

FIG. 2 is an end view of the storage tank of FIG. 1;

FIGS. 3A and 3B are end and side cross-sectional views, respectively illustrating one embodiment of arrangement of nozzles of an injection means inside the tank of FIG. 1,

FIG. 4 is a perspective view of the front wall of the inside of the tank of FIG. 3B;

FIG. 5 is a front view of low-profile rollers located along a bottom edge of an end of the tank of FIG. 1;

FIGS. 6A, 6B and 6C illustrate positions of the tank of FIG. 1 with respect to the low profile rollers during maneuvering of the tank inside a berm and after the tank have been positioned in the berm; more particularly FIGS. 6A and 6B are perspective side views of the tank in a manoeuvring position and a resting position, respectively and FIG. 6C is a plan view of two tanks in a resting position and one tank being manoeuvred;

FIG. 7 is a top perspective view of a tank farm comprising a plurality of storage tanks connected in parallel and located in a berm according to another embodiment;

FIG. 8 is a schematic view illustrating the interconnection means of FIG. 7 between the adjacent tanks;

FIG. 9 is a side view of the tank of FIG. 1 further illustrating accessories such as a cabinet, wind detection means and lighting means provided on the tank of FIG. 1;

FIG. 10 is a front view of one tank of FIG. 7 illustrating a cabinet housing an interconnection means;

FIG. 11 is a side perspective view of the cabinet of FIG. 10;

FIG. 12 is a schematic illustration of a portion of a piping arrangement;

FIG. 13 is a perspective, side cross-sectional view of a storage tank according to another embodiment; and

FIG. 14 is a front perspective view of the tank of FIG. 13 illustrating an interconnection means located in a cabinet at a front wall of the tank.

### DETAILED DESCRIPTION OF THE PREFERRED EMBODIMENTS

Herein, embodiments are directed to improvements to mud-storage tanks, such improvements including having superior debris handling, improved manoeuvrability in a berm environment and improved interconnectability.

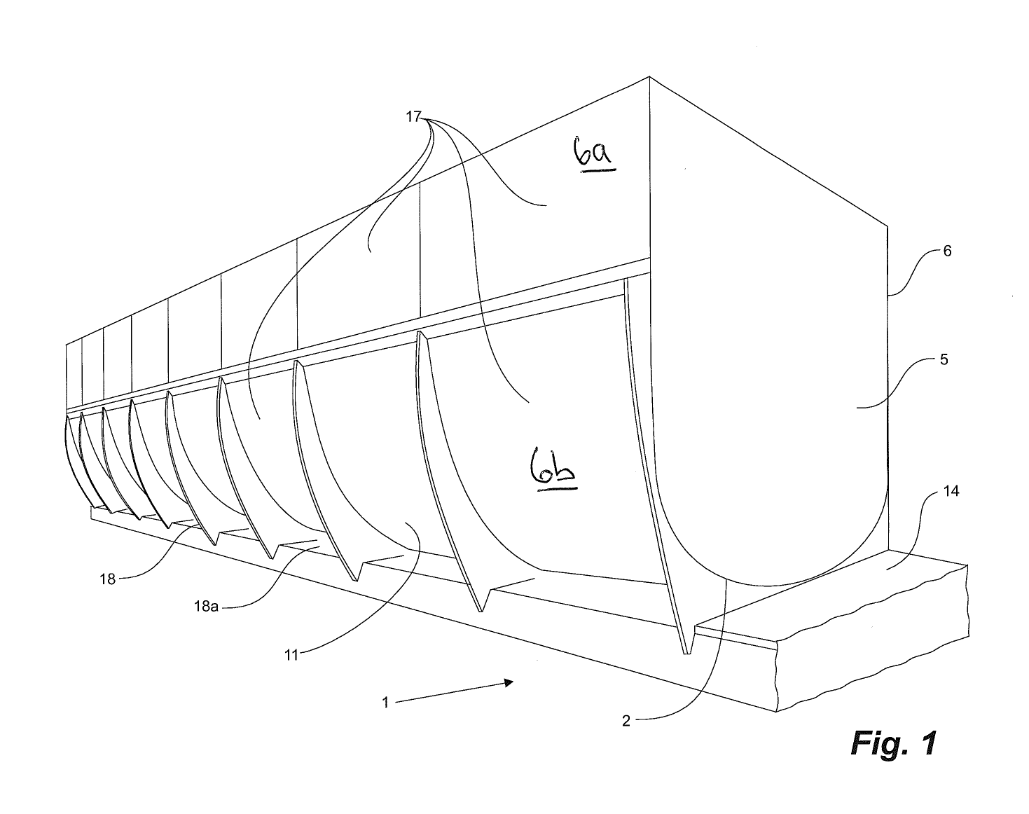

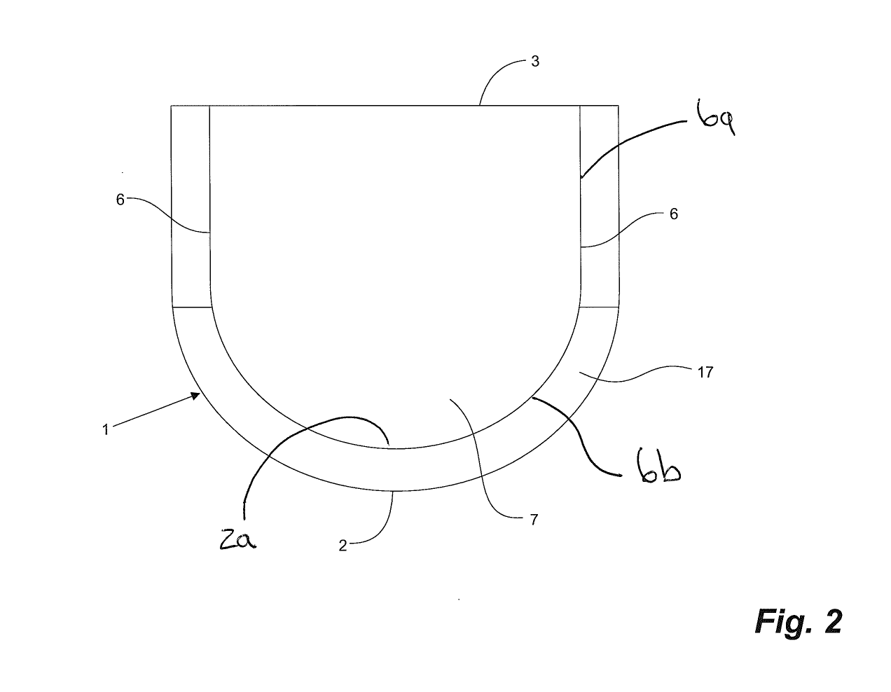

With reference to FIGS. 1 and 2, one embodiment of a tank 1 is shown for storing liquid such as drilling mud containing debris. The tank 1 comprises a liquid-containing volume defined by a bottom 2, a top wall 3, a front wall 4, a back wall 5 and sidewalls 6 defining an enclosed area 7. The front wall 4 and the back wall 5 are spaced longitudinally apart by the sidewalls 6. Each sidewall 6 has an upper portion 6a and a lower curved portion 6b. The lower curved portion 6b receives debris settling out of the liquid and directs at least some of the debris settling on the curved portion of the bottom 2 to a base 2a of the tank. The curved portion 6b urges debris settling from the liquid towards the bottom 2 of the tank 1. The curved geometry of the lower portion 6b poses no transition or interface to impede the movement of debris downward and toward the middle and lowest part specifically the base 2b of the tank 1. This minimizes the accumulation of debris on the inside surfaces of the tank 1 and the problems associated therewith. In one embodiment, the lower curved portion 6b of the tank 1 is semi-circular. Accordingly, as shown in FIG. 1, in another embodiment, the upper portion 6a is substantially vertical and the curved lower portion 6b is semi-circular. Accordingly, such a tank 1 has a D-shaped cross-section in a transverse direction.

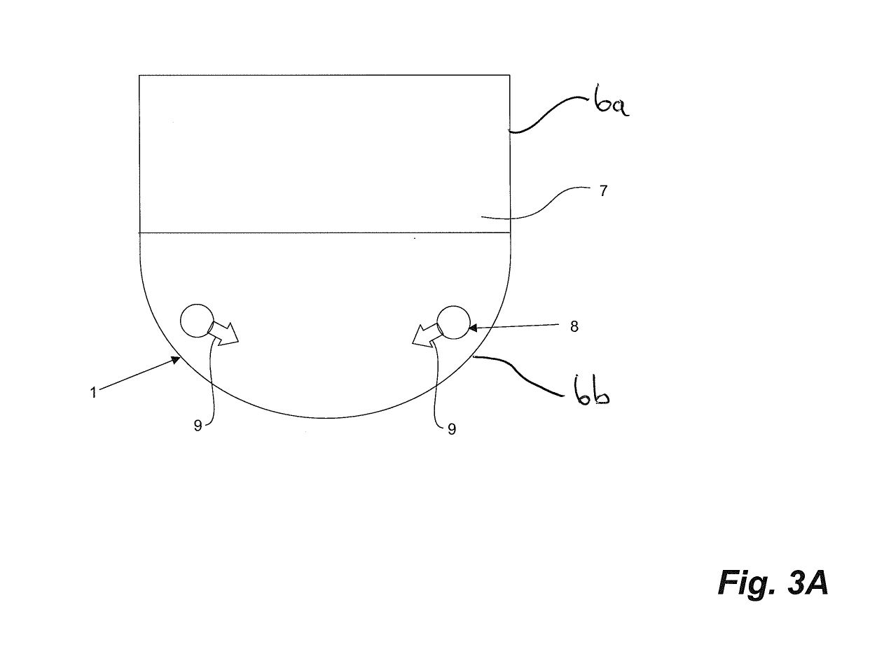

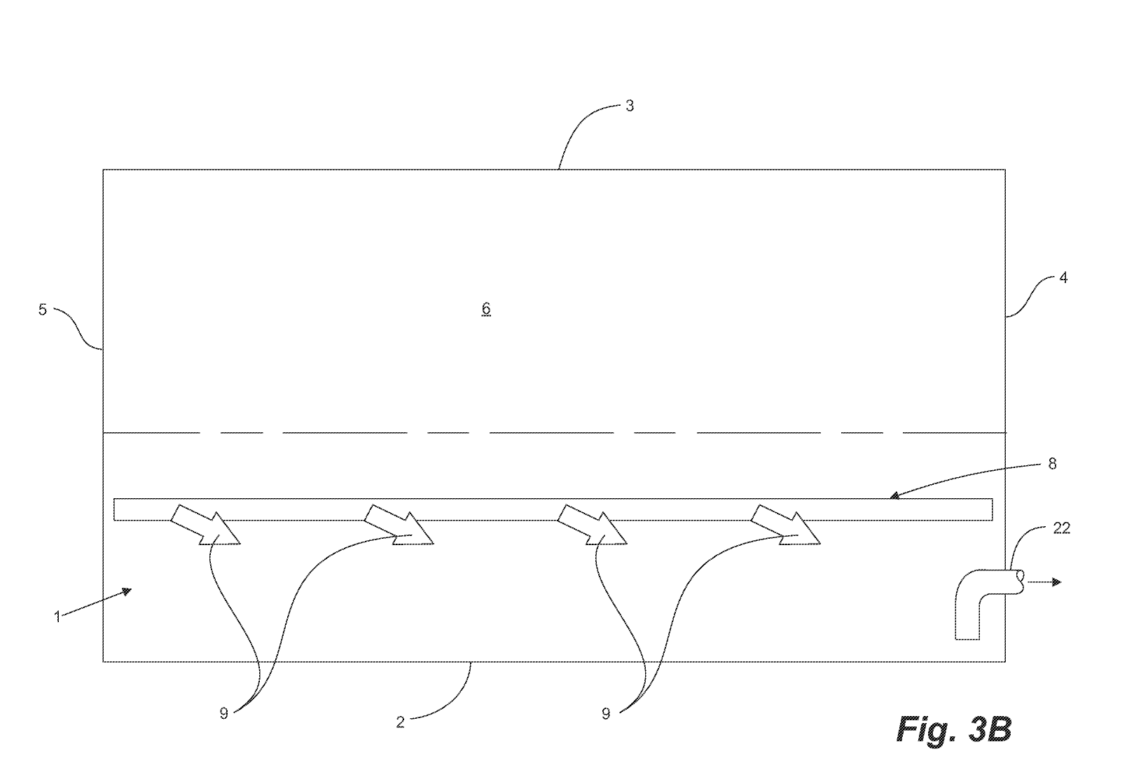

Further, as shown in FIGS. 3A and 3B, to aid in moving debris downwardly, the curved lower portion 6b of at least one of the two sidewalls 6 of the tank 1 is provided with a plurality of nozzles 9 spaced longitudinally along the curved lower portion 6b for directing flush liquid downwardly against the curved lower portion 6b for flushing any residual debris remaining thereon towards the base 2a of the tank. The nozzles 8 are angled such that the flush fluid follows the geometry of the lower curved portion 6b. A flush fluid-supply conduit 9a supplies flush fluid to the nozzles 8 and can extend longitudinally along the tank 1, at an elevation at about the transition from the side walls 6 to the bottom 2. The flush fluid can be clarified liquid or fresh liquid.

Each nozzle 9 can be manually adjusted to change their orientation. In one embodiment, the nozzles 9 are angled at least downwardly towards the bottom 2 of the tank, and as shown in FIG. 3A, also angled towards the tank discharge or outlet 22, shown here as located adjacent the front wall 4 of the tank 1 (see FIG. 3B). The nozzles 9 direct flush fluid towards the base 2a and towards the front wall 4 for urging debris towards the discharge 22. Accordingly, debris and mud are discouraged from settling or accumulating on these surfaces. Debris accumulated at the base 2a can be removed through the outlet 22. The tank 1 can also be provided with hatches (not shown) for hand-removal of debris.

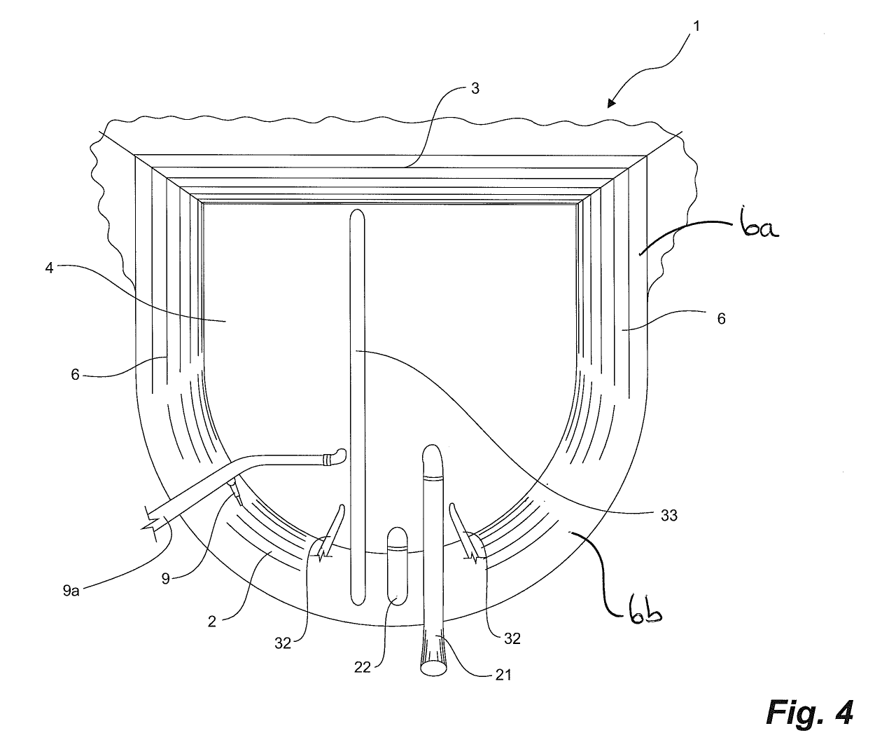

FIG. 4 is an inside view of the tank 1 illustrating one embodiment of the piping arrangement. Inlet 21 provides mud to the tank 1. Outlet 22 delivers mud from the tank 1 to a pumping station (not shown). Outlet 22 can also be used to remove debris settling out off the liquid in the tank 1. Flush fluid is provided to the nozzles 9 by the flush fluid-supply conduit 9a. Float line 33 enables measurement of the liquid level in the tank 1. Steam lines 32 can heat the liquid in the enclosed area 7, such as preventing the liquid from freezing.

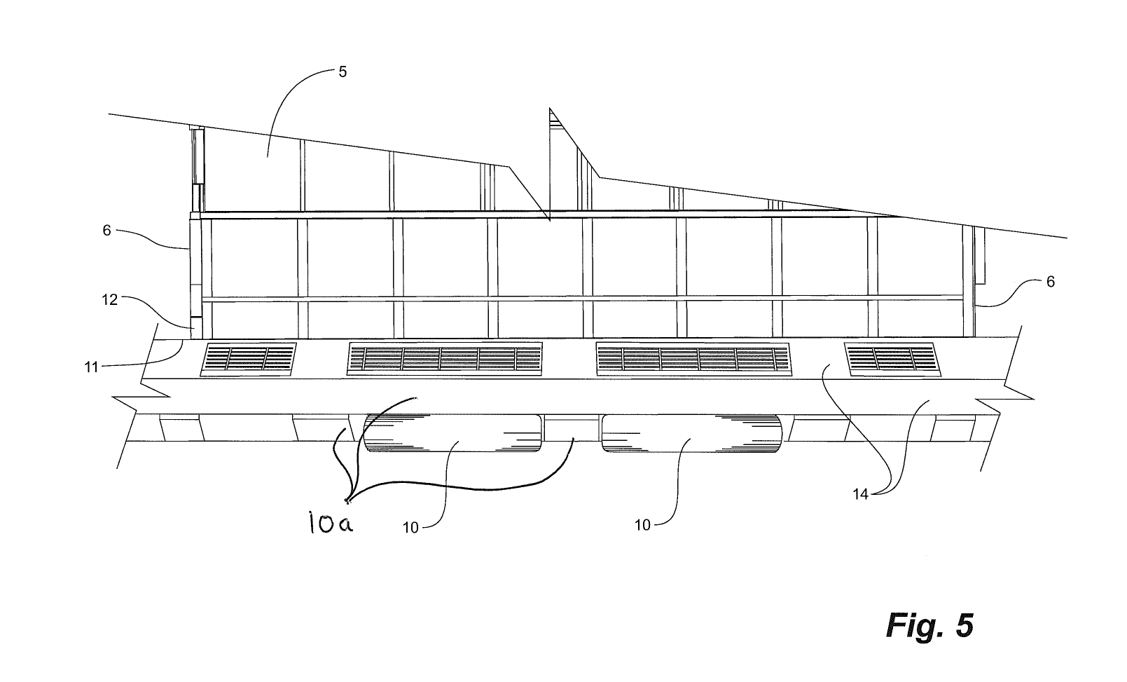

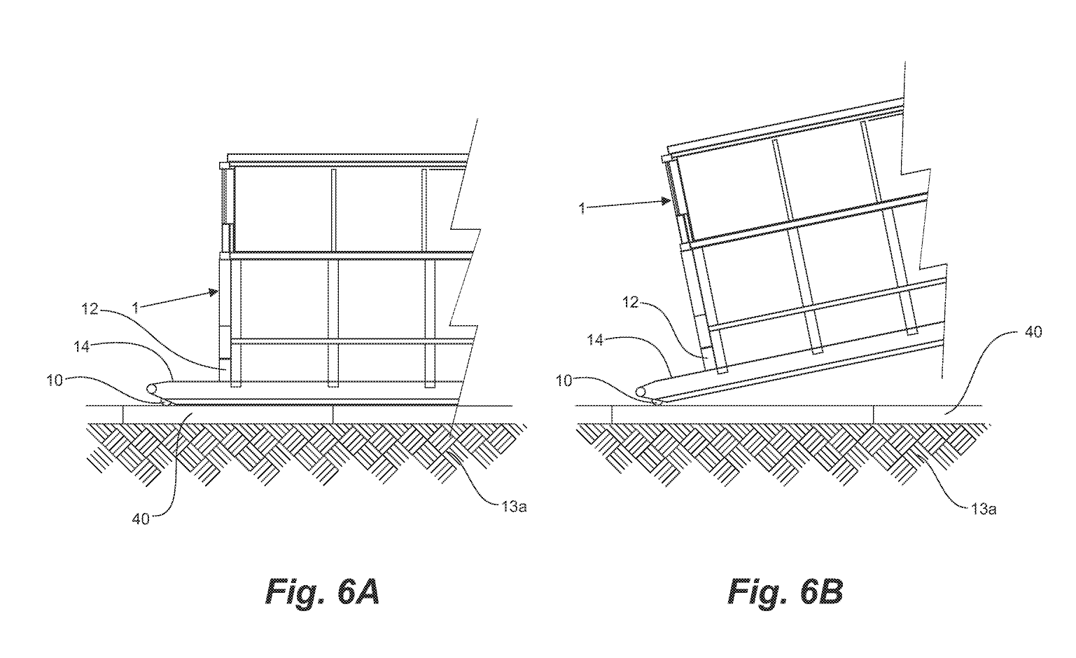

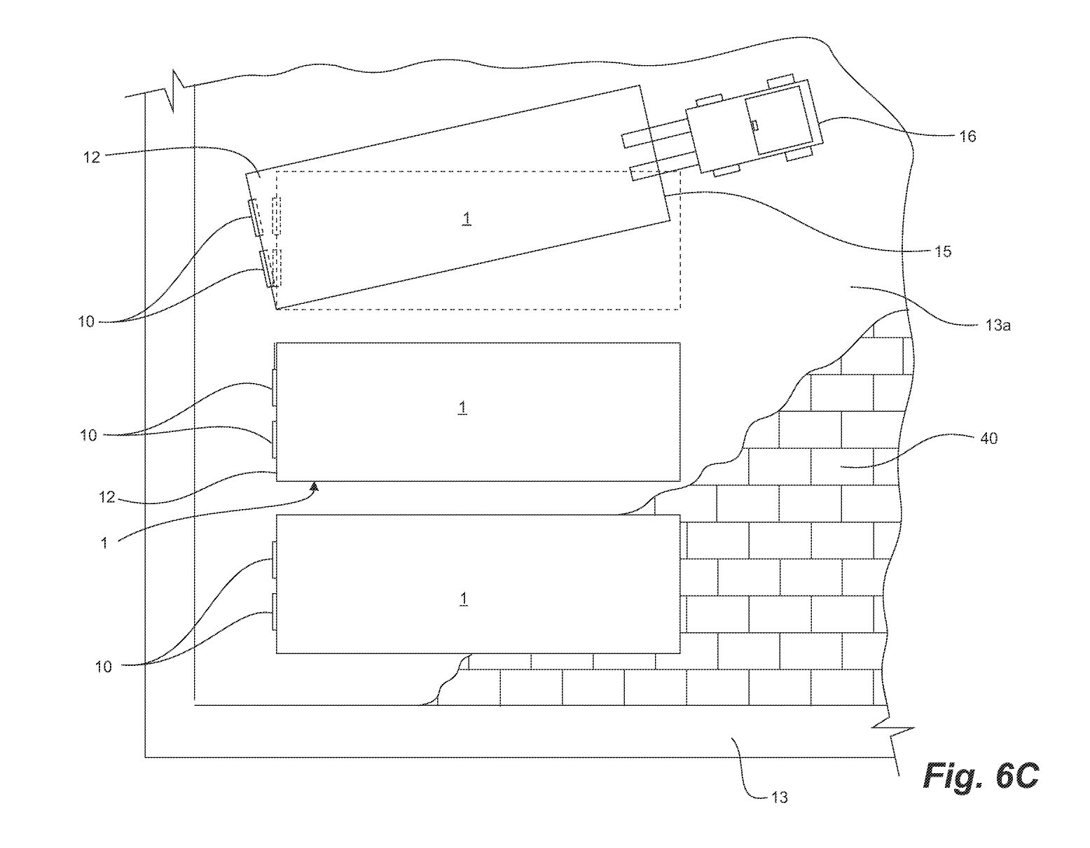

In another embodiment, as shown in FIGS. 5, 6A, 6B and 6C, to aid in manoeuvrability and placing of the tank, the tank 1 is provided with rollers 10. The rollers are located along a bottom edge 11 of a frame or skid 14 adjacent a first end 12 of the tank 1. In one embodiment, the first end 12 corresponds to the front wall 5. These rollers 10 aid in manoeuvring and positioning the tank 1 in a containment area or berm 13 (seen in FIG. 6C) after the tank 1 has been dropped off a transport truck. The skid 14 normally engages the ground or floor of the berm. The bottom of the tank 1 is supported in the skid 14 with suitable supports and structure. The skid 14 is typically a structure which extends longitudinally and laterally across a footprint of the tank 1. To permit manoeuvring without lifting of the entirety of the tank 1, the rollers 10 are located for movably supporting the first end 12 of the tank while lifting equipment lifts an opposing second end 15. The lifting equipment need only lift about one-half of the tank weight with a safety margin in reserve.

Depending upon the stability of the lifting equipment, the rollers 10 can correspondingly be placed or distributed as necessary, across a width of the first end 12, to assist in side-to side-stability.

The rollers 10 can be operative between a manoeuvring position and a resting position. The rollers 10 can be engaged in the manoeuvring position and rendered inoperative in the resting position through their relationship relative to the angle of the frame 14 when the tank 1 is alternated between being lifted, by lifting the second end 15, and being lowered to be placed completely on a floor 13a of the berm. The rollers 10 can be housed in a roller housing 10a located in the skid 14. The rollers 10 are at least partially recessed upwardly in the roller housing 10a, having a low profile. The rollers 10 selectively engage the floor 13a, for movably supporting the tank 1, only when the second end 15 is lifted. When the tank 1 is lowered, the tank's weight supported on the low-profile rollers 10 lessens and the rollers 10 may even become spaced from the floor 13a.

As shown in FIGS. 6A, 6B and 6C, the floor 13a can be somewhat protected using known rig mat systems 40. The rig mat system is a sectional, rigid mat providing a robust surface which can be assembled over the floor 13a of the berm 13. One or more barrier layers may also be laid between the rig mat 40 and the floor 13a. When the tank 1 is placed in the berm 13 and has to be manoeuvred, the tank is unloaded into the berm 13, to arrange the tank 1 in the berm or adjacent other tanks 1,1 . . . located in the berm 13. The tank 1 is manoeuvred by lifting the second end 15 of the tank 1 (as seen in FIG. 6C) off the floor 13a of the berm 13 with a lifting equipment such as a medium duty forklift 16 so that the low profile rollers 10 at the first end 12 engage rig mat system 40 or the floor 13a. In this position (FIG. 6B) the first end 12 and the corresponding weight of the tank 1 is supported by the rollers 10. The tank 1 is rolled along the floor 13a, without damage to the rig mats or underlying floor, and is manoeuvred into position within the berm 13. The rollers 10 engage the floor 13a and support the weight of the first end 12 of the tank 1 in a manoeuvring position for manoeuvring within the containment area 13 when the second end 15 of the tank is lifted off the floor 13a. The first end 12 and the second end 15 can be located either on the front wall 4 or the back wall 5. For a tank having a length of 46′, the rollers 10 are designed to movably engage the floor 13a with as little as an 18 inch lift at the second end 14. This means that large lifting equipment is not required to lift the end 14. A medium duty forklift 16 can comfortably achieve this lift. The rollers 10 provide a safe, quick method of positioning the tank 1 in the berm 13, which usually has tight space constraints. The rollers 10 allow large masses such as tanks weighing 500,000 pounds to be moved with much smaller equipment, such as that already on-site and without need for special hire. After placement, the tank 1 is lowered, substantially relieving any weight on the rollers 10 (as seen in FIG. 6A).

The movement of drilling fluids or mud to and from, and between, tanks is aided, particularly in cold climates, by heating or maintaining some heat in the mud. Accordingly, in an embodiment, tanks are insulated on an exterior of the tank. Insulation is vulnerable to mechanical damage. Transport, handling and manoeuvring of such tanks 1 can result in significant damage to exterior insulation. The enclosed area 7 of the tank 1 can also be provided with a steam line for keeping the liquid from freezing.

In one embodiment and as seen in FIGS. 1 and 2, an exterior of the lower curved portion 6b is provided with an insulation layer 17. The exterior of the tank 1 is provided with plurality of ribs 18, spaced longitudinally along the tank 1. Insulation 17 is located in the recess 18a formed between two adjacent ribs 18, 18.

The ribs 18 aid in protecting the insulation 17 from much of the longitudinal tearing and damage when the tank 1 is manoeuvred within tight spaces such as the berm 13. The ribs 18 and insulation 17 can also extend upward from the bottom 2 and along the side walls 6.

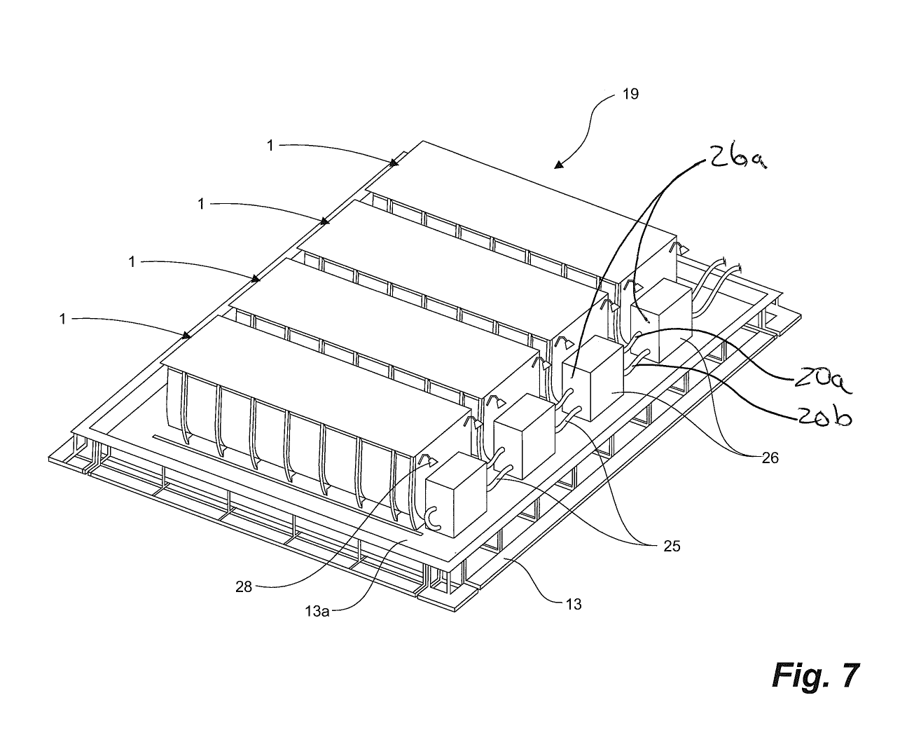

With reference to FIG. 7, in one embodiment, a plurality of tanks 1,1 . . . can be arranged side-by-side in a tank farm 19 for increased capacity and facility. Each tank 1 in the farm 19 has fluid inlet and fluid outlet for adding and removing mud from the respective tank 1. Conventional tank farms typically have external hoses and connectors hooking the tanks together resulting in many long cumbersome hoses and fittings interconnecting all the tanks which are vulnerable to leaks and acting as tripping hazards.

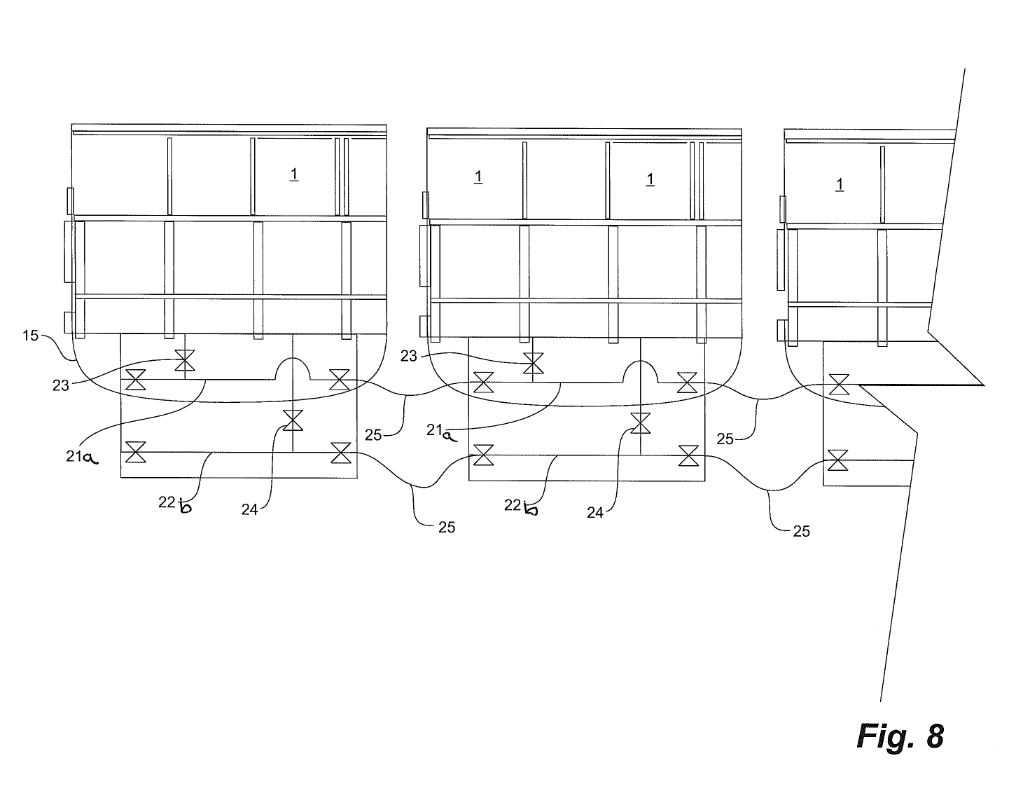

With reference to FIGS. 7 and 8, an interconnection means 20, as described herein, enables the tanks 1 to be fluidly connected in parallel for fluid operations to any one or more of the tanks 1. Each tank 1 and the interconnection means 20 are configured for ease of connection, a tidy arrangement of connecting fluid lines and flexibility of tank operations. Each tank 1 is fluidly connected in parallel by at least an outlet to an adjacent tank using fluid conduits connected between the at least one interconnection means 20 of each tank 1.

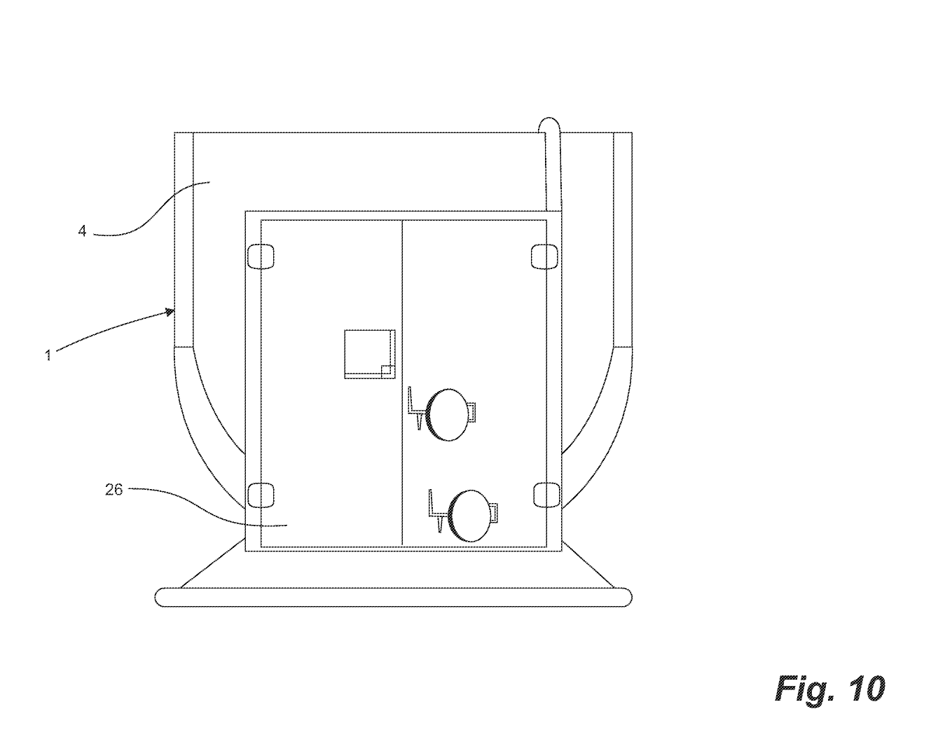

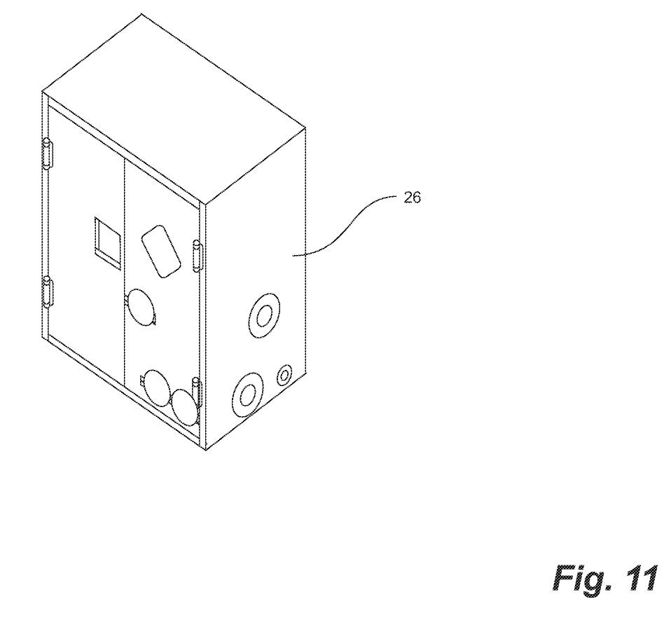

FIG. 8 illustrates a schematic representation of an embodiment of the interconnection means 20. An end of each tank 1, such as the end 15, is provided with an inlet manifold 21a and an outlet manifold 22a. The inlet manifold 21a and outlet manifold 22a are in fluid communication with the tank 1. In one embodiment and as seen in FIGS. 4, and 7 to 11, the inlet and outlet manifolds 21a, 22b, are housed in a cabinet 26 located at the front wall 4 of the tank 1. A first connection 20a is fluidly connected to the inlet manifold 21a at an interface 26a of the cabinet 26. A second connection 20b is fluidly connected to the inlet manifold 21a at an interface 26a of the cabinet 26. Each tank 1 is further provided with an inlet valve 23 between the inlet manifold 21a and the tank 1 and an outlet valve between 24 between the outlet manifold 22a and the tank 1. The inlet manifold 21a and the outlet manifold 22a of each tank have similar or identical configurations to the inlet and outlet manifolds of adjacent tanks 1, of the farm 19. The inlet manifold 21 and the outlet manifold 22 of a tank can be readily connected to the inlet manifold 21 and the outlet manifold 22 by the first connections 20a and the second connections 20b. In one embodiment, the first connections 20a and the second connections 20b are conduits. Such an arrangement enables each tank 1 in the farm 19 to circulate, to receive and dispense mud, independently or as a whole. Only one pump need be provided for the whole tank farm 19. However, a redundant pump may be provided as a backup. The interconnection means 20 simplifies the piping and reduces chances of leaks as there are less connection points, valves and pipes.

As the interconnection means 20 is located in the cabinet 26, offset from the ground, tripping hazards are eliminated. The cabinet 26, and in turn the interconnection means 20, can be heated to minimize the opportunity for the manifolds and the valves being frozen in cold climates. This ensures that the tanks 1,1 . . . in the farm 19 are reliably fluidly connected. In one embodiment, the cabinet 26 can be heated using a steam line 32 (as seen in FIG. 4).

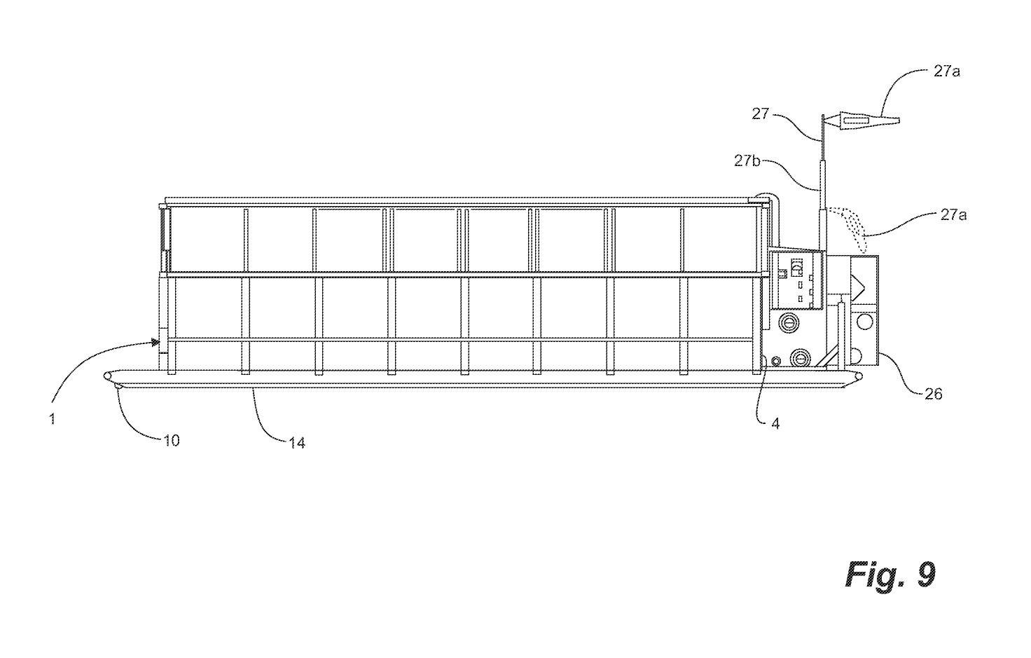

In one embodiment and as seen in FIGS. 7 and 9, the tank 1 is provided with accessories such as a wind direction detection means 27 and lighting means 28 which are telescopic. In one embodiment, the wind direction detection means 27 is a windsock 27a located on a telescopic tube 27b extending upwardly from the tank 1. The wind direction detection means 27 and the lighting means 28 are designed to telescopically collapse or fold up so that the tank 1 can be transported with no external piping or protrusions beyond standard transport limit.

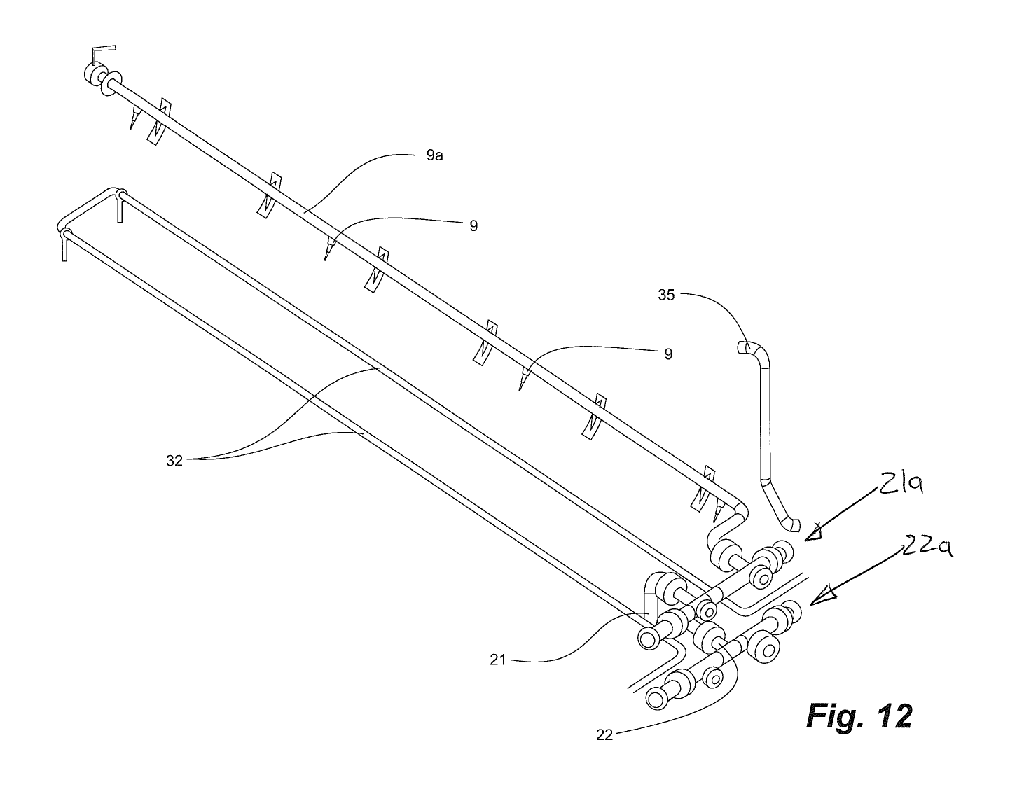

FIG. 12 is a schematic illustration of an essential portion of the piping arrangement of the tank of FIG. 1. Seen in FIG. 12 are the flush fluid-supply conduit 9a, the nozzles 9, the steam lines 32, the inlet manifold 21a and the outlet manifold 22b. 35 is a fill line which is used to deliver liquid to the tank 1 from a truck (not shown). The fill line 35 can be located outside the cabinet 26 as the fill line 35 does not contain any stagnant fluid and not susceptible to accidental freezing. In one embodiment, the inlet manifold 21a can also be used to deliver mud to the pumping station.

In one embodiment, the tank 1 is associated with a gauging system, conduit 33 of FIG. 4 for determining the level of liquid in the tank 1.

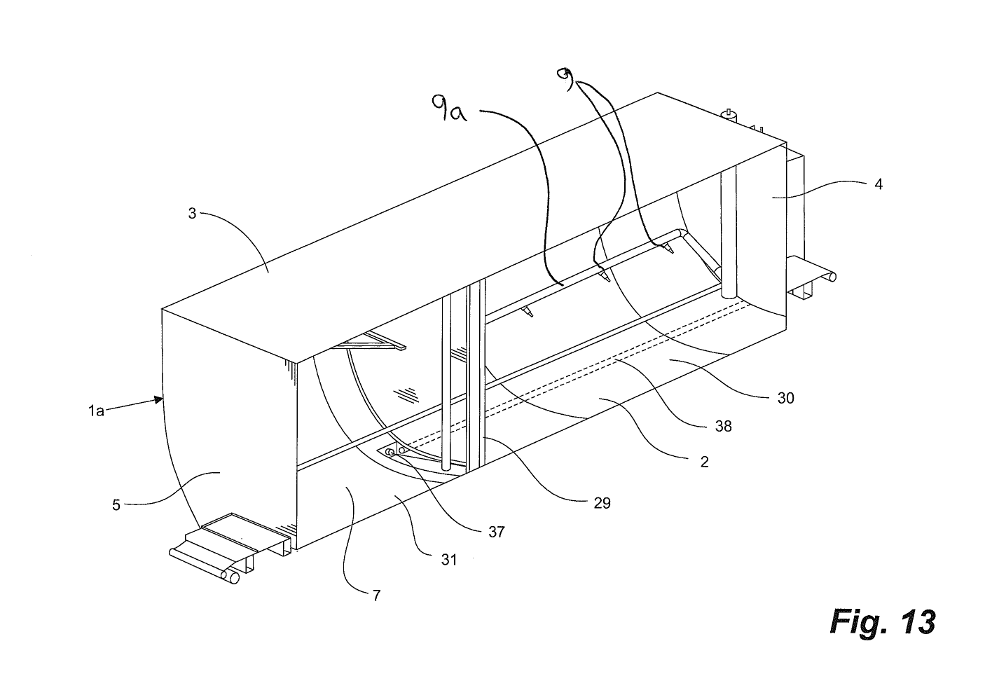

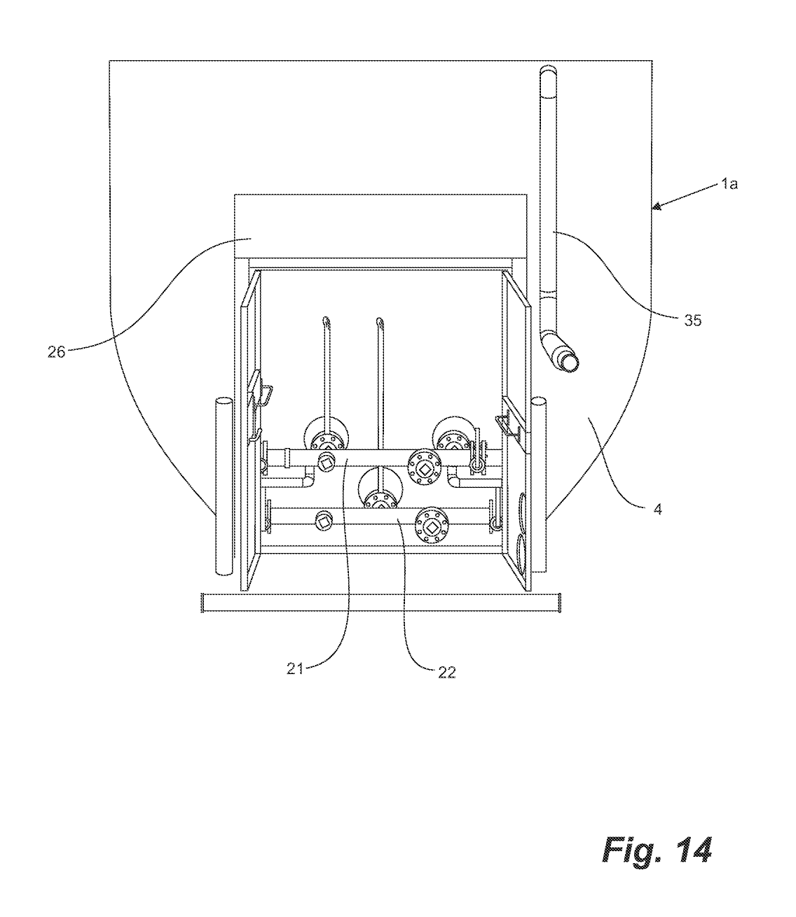

FIGS. 13 and 14 illustrate another embodiment of a storage tank. Tank 1a is illustrated in FIG. 13 is identical to the tank 1 illustrated in FIGS. 1 to 11 except that the enclosed area 7 of tank 1a is divided into two independent chambers. The enclosed area 7 of tank 1a comprises at least one partition plate 29 extending transversely between the sidewalls 6 for dividing the enclosed area 7 into at least two independent chambers 30 and 31. The partition plate extends upwardly from the bottom 2 of the tank 1a for dividing the tank 1a into two independent chambers 30 and 31. In one embodiment, the two chambers 30 and 31 store two different kinds of liquid. Liquid containing debris or used mud, is stored in the first independent chamber 30 which is defined by the partition plate 29 and the front wall 4 of the tank 1a. As chamber 30 stores liquid containing debris, the nozzles 9 are located in this chamber. Clear liquid or liquid not containing debris, fresh mud or base fluids, is stored in the second independent chamber 31 which is defined by the partition plate 29 and the back wall 5 of the tank 1a. Since the liquid stored in chamber 31 does not contain debris, the nozzles are not provided in this chamber. Chamber 31 is provided with a drain plug 37. Chamber 31 is also provided with a line 38 for fluidly connecting the chamber 31 to the inlet manifold 21 or outlet manifold 22 provided on the front surface 4 of the tank 1a. As seen in FIG. 14, the interconnection means including the inlet and outlet manifolds 21, 22 are housed in the cabinet 26 located at the front surface 4 of the tank 1.

The tank system described herein provides the following technical advances: ability to be dismantled and moved with ease, ability to reduce component count for valves, piping, circulation pumps, easy installation and repair, increased safety of workplace, modular system to allow scalability, improved mud clean out methods, and improved positioning methods for installation/tear down.

1. A storage tank system for the storage of liquid, containing debris, comprising:
a tank having a front wall and a back wall spaced longitudinally apart by two sidewalls for defining an enclosed area for storing the liquid, each sidewall having an upper portion and a curved lower portion forming a bottom, the curved lower portion receiving debris settling out of the liquid and directing at least some of the debris to a base of the bottom the tank; and
a plurality of nozzles spaced longitudinally along the curved lower portion of at least one of two sidewalls for directing flush liquid downwardly against the curved lower portion for flushing any residual debris remaining thereon towards the base of the tank.

2. The storage tank system of claim 1 wherein the curved lower portion is semi-circular.

3. The storage tank system of claim 1 wherein the upper portion is substantially vertical and the curved lower portion is semi-circular, the tank having a D-shaped cross-section in a transverse direction.

4. The storage tank system of claim 1 wherein one or more of the plurality of nozzles are further directed towards an outlet located on the front wall of the tank.

5. The storage tank system of claim 1 wherein at least the curved lower portion of the sidewalls is provided with an insulation layer over an exterior of the curved lower portion, for maintaining the fluid properties of the liquid in the tank.

6. The storage tank system of claim 5 wherein at least the sidewalls are provided with ribs, spaced longitudinally along the tanks, the insulation being located between the ribs.

7. The storage tank system of claim 1 further comprising at least one partition plate extending transversely between the sidewalls for dividing the enclosed area into at least two independent chambers.

8. The storage tank system of claim 7 wherein the plurality of nozzles are located in a first independent chamber, of the at least two independent chambers, the first independent chamber being located between the at least one partition plate and the front wall of the tank.

9. The storage tank system of claim 7 wherein the second independent chamber, of the at least two independent chambers, contains clear fluid, the second independent chamber is located between the at least one partition plate and the back wall of the tank.

10. A storage tank system in a containment area, comprising:
a tank having a bottom, a front wall and a back wall spaced longitudinally apart by two sidewalls for defining an enclosed area for storing the liquid
a skid extending along the tank for supporting the bottom of the tank and engaging a floor of the containment area; and
rollers are located along a bottom edge of the skid adjacent a first end of the tank, being either the front wall or the back wall, for engaging the floor and supporting the weight of the first end of the tank in a manoeuvring position for manoeuvring within the containment area when a second end of the tank, being either the front wall or the back wall respectively, is lifted off the floor.

11. The storage tank system of claim 10 the skid further comprises:
a roller housing wherein the rollers are at least partially recessed upwardly therein, and
wherein when the second end of the skid is lowered to the floor in a resting position, the rollers substantially disengage from the floor.

12. A storage tank farm comprising:
a plurality of the tanks of claim 1, each tank having at least one interconnection means, and
wherein each tank is fluidly connected in parallel by at least an outlet to an adjacent tank using fluid conduits connected between the at least one interconnection means of each tank.

13. The tank farm of claim 12 wherein the interconnection means is located in a heated cabinet located on the front wall of each tank.

14. The tank farm of claim 13 wherein each interconnection means further comprises:
an inlet manifold and an outlet manifold in fluid communication with the tank, and
a first connection fluidly connected to the inlet manifold and located at a interface to the heated cabinet;
a second connection fluidly connected to the outlet manifold and located at a interface to the heated cabinet; and
wherein the first connections of adjacent tanks are interconnected, and the second connections of adjacent tanks are interconnected.

15. The tank farm of claim 13 wherein each interconnection means further comprises:
a inlet valve between the inlet manifold and the tank and an outlet valve between the outlet manifold and the tank.
